(19) United States
(12) Patent Application Publication
(10) Pub. No.: US 2016/0066591 A1
(43) Pub. Date: Mar. 10, 2016

(54) A BEVERAGE PREPARATION SYSTEM, A CAPSULE AND A METHOD FOR FORMING A BEVERAGE

(71) Applicant: KRAFT FOODS R&D, INC., Deerfield, IL (US)

(72) Inventors: Andrew Halliday, Banbury (GB); Daniel Ahearn, Cambridge (GB); Andrew Chapman, Peterborough (GB); Esak Shabudin, Banbury (GB)

(21) Appl. No.: 14/786,136

(22) PCT Filed: May 16, 2014
(86) PCT No.: PCT/IB2014/000957

§ 371 Date: Oct. 21, 2015

(30) Foreign Application Priority Data
May 17, 2013 (GB) 1308929.7

(51) Int. Cl. A23F 5/26; B65D 85/804; A47J 31/40

(52) U.S. Cl. CPC A23F 5/262; A47J 31/407; B65D 85/8043

(57) ABSTRACT

A beverage producing system is provided comprising a capsule (1) containing beverage ingredients and a beverage preparation machine. The capsule (1) comprises a cup-shaped body (40) and a lid (41); the cup-shaped body (40) having a base (42) and a side wall (43) and the lid (41) being sealed to the cup-shaped body (40). At least a portion of the cup-shaped body is formed from a laminate material comprising at least an aluminium layer (71) and a polymer layer (72). A capsule and a method are also disclosed.

The present disclosure relates to a beverage preparation system, a capsule and a method for forming a beverage. The beverage preparation system is of the type comprising a beverage preparation machine wherein the capsule is designed for insertion into the beverage preparation machine to permit a pressurised liquid to be flowed through the capsule in order to produce a beverage from interaction with beverage ingredients contained within the capsule.

### BACKGROUND

Beverage preparation systems which comprise a beverage preparation machine and a capsule containing beverage ingredients are known in the art. One such system is taught in EP 1700548, which discloses a capsule comprising a cup-like base body and a closing foil member. The capsule is designed for insertion in a beverage production device in which a liquid under pressure enters the capsule in order to interact with ingredients in the capsule to form a beverage which is output for consumption. The capsule of EP 1700548 is provided with a dedicated sealing member to prevent a by-pass flow of water around the exterior of the capsule in use. The sealing member is in the form of a hollow sealing member on the outer surface of the capsule, for example in the form of a step which is contacted on closure of an enclosing member of the beverage preparation machine. Alternatively, a separate sealing member is taught which can be attached to the surface of the capsule or cured in place on the formed capsule.

The present disclosure provides an alternative capsule which may be used as part of such a beverage preparation system. The capsule may be economical to produce and provide effective sealing in use.

### Summary of the Disclosure

In a first aspect the present disclosure provides a beverage producing system comprising:

a capsule containing beverage ingredients; and a beverage preparation machine;

the capsule comprising a cup-shaped body and a lid; the cup-shaped body having a base and a side wall and the lid being sealed to the cup-shaped body;

the capsule being designed for insertion into the beverage preparation machine to permit a pressurised liquid to be flowed through the capsule in order to produce a beverage from interaction with the beverage ingredients;

the beverage preparation machine having an enclosing member adapted to be selectively movable between an open position to permit insertion of the capsule into the beverage preparation machine and a closed position in which the enclosing member sealingly engages the capsule;

wherein at least a portion of the cup-shaped body is formed from a laminate material comprising at least an aluminium layer and a polymer layer.

In a second aspect, the present disclosure provides a capsule for preparing a beverage comprising a cup-shaped body and a lid; the cup-shaped body having a base and a side wall and the lid being sealed to the cup-shaped body;

the capsule being designed for insertion into a beverage preparation machine to permit a pressurised liquid to be flowed through the capsule in order to produce a beverage from interaction with the beverage ingredients;

the beverage preparation machine being of the type having an enclosing member adapted to be selectively movable between an open position to permit insertion of the capsule into the beverage preparation machine and a closed position in which the enclosing member sealingly engages the capsule;

wherein at least a portion of the cup-shaped body is formed from a laminate material comprising at least an aluminium layer and a polymer layer.

In a third aspect the present disclosure provides a method for preparing a beverage comprising the steps of:
providing a capsule as described above;
providing a beverage preparation machine having an enclosing member;
moving the enclosing member into an open position;
inserting the capsule into the beverage preparation machine;
closing the enclosing member so as to sealingly engage the enclosing member with the capsule;
flowing a pressurised liquid through the capsule to produce a beverage from interaction with the beverage ingredients; and
outputting the beverage for consumption;

wherein on closure, the enclosing member engages the laminate material of the capsule to thereby form at least one sealing interface between the enclosing member and the capsule.

The above aspects may further comprise one or more of the following features:

The cup-shaped body may comprise an outwardly-extending flange at an end of the capsule distal the base.

The outwardly-extending flange may be formed from the laminate material.

The cup-shaped body may be wholly formed from the laminate material.

The cup-shaped body may comprise a unitary piece of laminate material.

The laminate material may, in some aspects, comprise only a single aluminium layer and a single polymer layer (with optionally one or more lacquer layers, tie layers or adhesive layers). Advantageously, this helps to reduce the cost and manufacturing complexity of the capsule.

The polymer layer may comprise a material selected from the group of: polyvinyl chloride (PVC), polypropylene (PP), low density polyethylene (LDPE), medium density polyethylene (MDPE), high density polyethylene (HDPE), fluorinated ethylene propylene (FEP), polytetrafluoroethylene (PTFE), polyethylene terephthalate (PET), polyamide (PA), ethylene propylene diene monomer (EPDM), polychloroprene or isobutylene.

The polymer of the polymer layer preferably has a hardness of less than or equal to 40 D Shore Hardness. Advantageously, using a relatively soft polymer for the outer layer of the laminate allows the material to deform around imperfections and features of the enclosing member to provide a more effective hydraulic seal.

The polymer layer may have a thickness greater than or equal to 100 microns. Preferably, the polymer layer may have a thickness greater than or equal to 120 microns. In some examples, the polymer layer may have a thickness greater than or equal to 130 microns. Preferably, the polymer layer has a thickness no more than 300 microns. Advantageously, combining a relatively soft polymer of less than or equal to 40 D Shore Hardness with a relatively thick layer of greater than or equal to 100 microns beneficially results in a material that can deform sufficiently to seal around moderately sized imperfections and features of the enclosing member without requiring too high a closing force on the enclosing member to operate.

The aluminium layer of the laminate material may be formed from aluminium or an aluminium alloy. The aluminium alloy may, for example, be of grade 3005, 3105, 8011 or 8079. The aluminium alloy may have an ‘0’ temper rating.

The aluminium layer may have a thickness in the range of 80 to 150 microns.

The laminate material may be adapted such that, in use, closure of the enclosing member deforms the polymer layer to thereby form a sealing interface between the capsule and the enclosing member.

The laminate material may be adapted to form a sealing interface with a leading edge of the enclosing member.

Advantageously, the deformation of the laminate material due to the compressibility of the polymer layer allows for the laminate material to conform to the shape of the leading edge of the enclosing member. In particular the polymer layer is able to fill any gaps arising due to the presence of grooves in the leading edge.

The laminate material may be adapted to be nipped against a capsule holder of the beverage preparation machine part.

The outwardly-extending flange may comprise at least one raised ridge formed from the laminate material. The at least one raised ridge may be on the side of the outwardly-extending flange that faces away from the lid.

On closure of the enclosing member a leading edge of the enclosing member may contact the at least one raised ridge and forms a seal therewith.

The raised ridge may comprise an apex that is located at a higher level relative to a remainder of the flange.

The raised ridge may comprise an inner wall facing the side wall. On closure of the enclosing member a leading edge of the enclosing member may contact the inner wall of the raised ridge and forms a seal Therewith.

The inner wall of the raised ridge may be angled, such that an angle a at a junction between a remainder of the flange and the inner wall is from 90° to 120°, preferably 105°. Thus the seal with the enclosing member may be a tapered seal.

The raised ridge may comprise an apex, and a leading edge of the enclosing member may comprise an inner rim and an outer rim and a recess located between the inner rim and the outer rim, wherein on closure of the enclosing member the apex of the raised ridge may be received in the recess between the inner rim and the outer rim.

The raised ridge may have a height of 0.75 to 2.5 mm, preferably 1.0 to 1.5 mm, more preferably 1.3 mm.

The polymer layer may be provided towards an exterior of the capsule and the aluminium layer may be provided towards an interior of the capsule. This has been found to provide an improved sealing interface with the leading edge of the enclosing member.

The laminate material may further comprise a lacquer layer. The lacquer layer may be applied to the aluminium layer. The lacquer layer may assist in preventing flavour-contamination of the beverage ingredients.

The cup-shaped body may be a cold-formed cup-shaped body. Advantageously, the laminate material comprising the aluminium layer and the polymer layer may be cold drawn thus avoiding the need to attach a separate sealing member in another manufacturing step or apply and cure a polymer on to an already drawn aluminium component in another manufacturing step. A deep-drawing technique may be used to cold form the cup-shaped body. As an alternative to cold-forming, a warm-drawing technique may be used where the material is subjected to an increased temperature to promote easier deformation of the polymer material but without detrimental effects on the material characteristics of the aluminium layer.

The capsule may further comprise a rim. The rim may be integral with the cup-shaped body. The rim may be formed by a rolled-over portion of the side wall.

The side wall may comprise a frustoconical section.

The lid may be sealed to an outwardly-extending flange of the cup-shaped body.

The lid may be sealed to the side wall at a location spaced from an outwardly-extending flange of the cup-shaped body.

The lid may be formed from aluminium, an aluminium alloy or a laminate comprising at least one layer formed from aluminium or an aluminium alloy. Alternatively, another, suitably ductile material could be utilised. The lid may further comprise a heat seal lacquer or heat seal layer to enhance sealing of the lid to the cup-shaped body.

The rim may have an outer diameter of approximately 37 mm.

Prior to insertion, the capsule may have a height of from 25 to 31 mm. In some aspects the height may be from 28.5 to 30 mm.

Preferably, the cup-shaped bodies may be shaped in a way that can be stacked and destacked easily prior to filling and assembly with the lids.

The capsule may form a single-use, disposable element.

The capsule may contain a beverage ingredient or mixture of beverage ingredients. As a non-limiting example, the beverage ingredient may comprise roasted ground coffee.

### BRIEF DESCRIPTION OF THE DRAWINGS

Examples of the present disclosure will now be described in more detail, for exemplary purposes only, with reference to the accompanying drawings, in which:

FIG. 1 is a cross-sectional view of a first embodiment of capsule according to the present disclosure;

FIG. 2 is a schematic illustration of a detail of the capsule of FIG. 1 with an enclosing member of a beverage preparation machine in a closed position;

FIG. 3 is a schematic cross-section of a laminate material of the capsule of FIG. 1;

FIG. 4 is a cross-sectional view of a second embodiment of capsule according to the present disclosure; and

FIG. 5 is a schematic illustration of a detail of the capsule of FIG. 4 with an enclosing member of a beverage preparation machine in a closed position.

### DETAILED DESCRIPTION

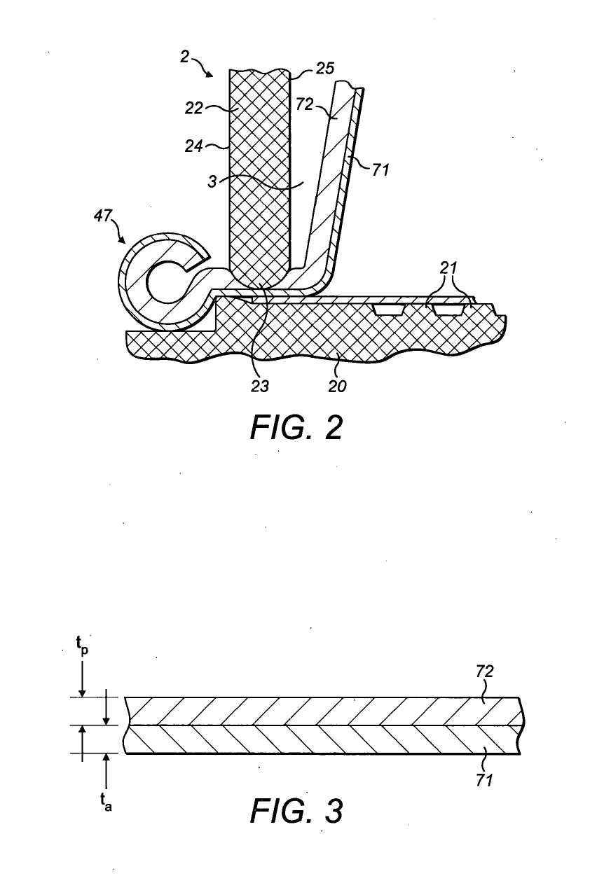

FIG. 2 shows schematically a part of a beverage preparation system according to the present disclosure. The beverage preparation system comprises a beverage preparation machine and a capsule 1.

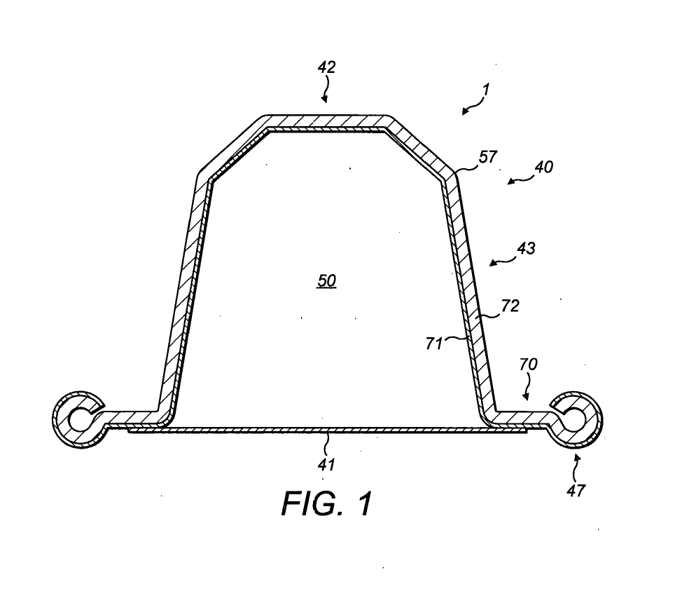

FIG. 1 shows a first embodiment of the capsule 1. The capsule 1 will be described in more detail below but may have the general form of a cup-shaped body 40 having a base 42 at one end and a side wall 43 extending from the base 42 towards an opposed end which is closed-off by a lid 41.

As shown in FIG. 2, the beverage preparation machine comprises an enclosing member 2 and a capsule holder 20. The enclosing member 2 is selectively movable relative to a capsule holder 20 between an open position, to permit insertion of the capsule 1 into the beverage preparation machine, and a closed position, in which the enclosing member 2 sealingly engages the capsule 1 against the capsule holder 20 in a manner that will be described below.

The enclosing member 2 may be moved between the open and closed positions by means of a conventional mechanism well known in the art. For example, the means may involve a mechanical mechanism activated by a manually-movable lever or an automatic or semi-automatic mechanism where movement is driven by a motor. The enclosing member 2 may be moved while the capsule holder 20 remains stationary. Alternatively, the enclosing member 2 may remain stationary and the capsule holder 20 be moved. In a further alternative arrangement, both the enclosing member 2 and the capsule holder 20 may move during the opening and closing operations.

The enclosing member 2 and the capsule holder 20 in the closed position together define a receptacle 3 for holding the capsule 1 during a dispensing operation.

The beverage preparation machine may further comprise other conventional elements which are not illustrated in the accompanying drawings and are well known in the art of beverage preparation machines. For example, the beverage preparation machine may comprise either a facility for storing an aqueous medium, such as an internal reservoir, or a facility for connection to an external supply of aqueous medium, such as mains water. The aqueous medium will typically be water. A pump or equivalent may be provided for supplying the aqueous medium in a pressurised state to the capsule 1. The aqueous medium will typically be supplied at a pressure of up to 9 to 14 bar. A heater may be provided for heating the aqueous medium to a desired temperature. The heater may heat the aqueous medium in the reservoir (where present) or may heat the aqueous medium on-demand as it passes through a conduit or over a thermoblock to the receptacle 3. The beverage preparation machine may comprise base piercing means for piercing the base 42 of the capsule 1 to permit the aqueous medium to enter the capsule 1 and interact with the beverage ingredients therein. Alternatively, the capsule 1 may be provided with one or more pre-formed openings to allow entry of the aqueous medium from the receptacle 3 into the capsule 1.

The enclosing member 2 may be of the type described in EP 1700548 comprising an annular element 22 having a leading edge 23 in the form of an annular rim, an inner face 25 facing the receptacle 3 and an outer face 24 facing an exterior. The leading edge 23 may be provided with a plurality of grooves as taught in EP 1700548. An upper end (not shown) of the enclosing member 2 may be coupled to a supply of the aqueous medium and may provide a mounting for one or more perforation elements intended to pierce the base 42 of the capsule 1 in use. The capsule holder 20 may be of the type described in EP 1700548 comprising relief elements 21 which are designed to tear and perforate the lid 41 of the capsule 1. The tearing of the lid 41 may occur due to internal pressurisation of the capsule 1 caused by inflowing aqueous medium. The relief elements 21 may have any protruding shape able to cause a partial tearing of the foil member, e.g. pyramids, needles, bumps, cylinders, or elongated ribs.

As shown in FIG. 1, the cup-shaped body 40 and the lid 41 of the capsule 1 together enclose a beverage ingredient chamber 50 which may be filled with a beverage ingredient or mixture of beverage ingredients. As a non-limiting example, the beverage ingredient may comprise roasted ground coffee.

At least a portion of the cup-shaped body 40 utilised for sealing with the enclosing member 2 is made from a laminate material comprising at least an aluminium layer 71 and a polymer layer 72 together, optionally, with one or more tie layers and/or adhesive layers as necessary to bond together the layers 71 and 72. Additionally, the laminate may comprise one or more lacquer layers on its inner and/or outer surface. The general structure of the laminate material is shown in FIG. 3—the tie and/or adhesive and/or lacquer layers are omitted from the drawing for clarity as they are very thin relative to the layers 71 and 72. The polymer layer 72 provides a compressible structure that aids sealing.

The cup-shaped body 40 includes the base 42 and the side wall 43. There may be, as illustrated, a geometric discontinuity at the junction between the base 42 and the side wall 43, for example, in the form of a shoulder 57. Alternatively, the base 42 and the side wall 43 may have a smooth geometric transition.

The side wall 43 of the cup-shaped body 40 may comprise, as shown, an outwardly-extending flange 70 at an end of the capsule 1 distal the base 42. In which case, preferably the whole of the flange 70 is made from the laminate material. The flange 70 may be provided with a rim 47 which may be formed by a rolled-over section of the flange.

More preferably the whole of the cup-shaped body 40 is made from the laminate material, including the flange 70 and rim 47 where present. Also, preferably, the cup-shaped body 40 is formed from a unitary piece of the laminate material.

The cup-shaped body 40 may be formed by cold or warm drawing the laminate material.

The polymer layer 72 may comprise a material selected from the group of: polyvinyl chloride (PVC), polypropylene (PP), low density polyethylene (LDPE), medium density polyethylene (MDPE), high density polyethylene (HDPE), fluorinated ethylene propylene (FEP), polytetrafluoroethylene (PTFE), polyethylene terephthalate (PET), polyamide (PA), ethylene propylene diene monomer (EPDM), polychloroprene or isobutylene.

The polymer layer 72 may have a thickness tₚ greater than or equal to 100 microns. Preferably, the polymer layer 72 may have a thickness tₚ greater than or equal to 120 microns. In some examples, the polymer layer 72 has a thickness tₚ greater than or equal to 130 microns.

However, it is preferred that the polymer layer 72 has a thickness tₚ no more than 300 microns.

The aluminium layer 71 may have a thickness tₐ in the range of 80 to 150 microns.

The polymer layer 72 is provided towards an exterior of the capsule 1 to be contacted by the enclosing member 2 and the aluminium layer 71 is provided towards an interior of the capsule 1.

A lacquer layer may be provided which may be applied to the aluminium layer 71.

The laminate material may also comprise a printed layer facing the exterior of the capsule 1, to allow the provision of text, pictures, logos, etc.

The lid 41 may be sealed to an underside of the outwardly-extending flange 70. Alternatively, the lid 41 could be sealed to the side wall 43 at a location spaced from the outwardly-extending flange 70 of the cup-shaped body 40.

The lid 41 may be formed from aluminium or a laminate containing aluminium.

In use of the beverage preparation system the enclosing member 2 is first moved into the open position and the capsule 1 is inserted into a location in between the capsule holder 20 and the enclosing member 2. Depending on the design of the beverage preparation machine, the capsule 1 may be inserted by gravity or by manual placement or a combination thereof. In addition, the initial insertion may place the capsule 1 in proximity to the enclosing member 2 such that subsequent movement of the enclosing member 2 carries the capsule 1 therewith into engagement with the capsule holder 20. Alternatively, initial insertion may place the capsule 1 in proximity to the capsule holder 20 such that the capsule 1 remains substantially stationary during closure of the enclosing member 2.

The enclosing member 2 is then closed so as to sealingly engage the enclosing member 2 with the capsule 1. During this step the base 42 of the capsule 1 may be pierced by the perforation elements of the enclosing member 2.

Pressurised aqueous medium is then flowed into the capsule 1 to produce a beverage from interaction with the beverage ingredients. During this step internal pressurisation of the beverage ingredient chamber 50 causes the lid 41 to be deformed outwardly against the relief elements 21 of the capsule holder 20 resulting in at least partial tearing of the lid 41 which opens up an exit path from the capsule 1 for the beverage.

The beverage is then output for consumption.

As shown in FIG. 2, during the step of closing the enclosing member 2 relative to the capsule holder 20 the flange 70 (or other part of the side wall 43) of the capsule 1 is contacted by the enclosing member 2 to deform the flange 70 (or other part of the side wall 43). In the example shown, the enclosing member 2 contacts the flange 70 only. However, other arrangements are contemplated by the present disclosure whereby the enclosing member 2 contacts a different portion of the side wall 43, e.g. a frustoconical portion, or contacts multiple locations of the capsule 1.

The leading edge 23 contacts and bears on the laminate material of the side wall 43 and nips the laminate material against the capsule holder 20. The enclosing member 2 thereby deforms at least the polymer layer 72 of the laminate material forming a sealing interface between the enclosing member 2 and the capsule 1. The deformation of the laminate material due to the compressibility of the polymer layer 72 allows for the laminate material to conform to the shape of the leading edge 23. In particular the polymer layer 72 is able to fill any gaps arising due to the presence of grooves in the leading edge 23. In addition, during use the hot water passed through the receptacle 3 may act to slightly soften the material of the polymer layer. Such softening may lead to further deformation of the side wall 43 under the compressive loading of the enclosing member 2. This effect may help to reinforce the fluid seal between the enclosing member 2 and the capsule 1 by tending to seal up any gaps having hot water leaking there through.

The deformation of the polymer layer 72 may be elastic, plastic or a combination of the two.

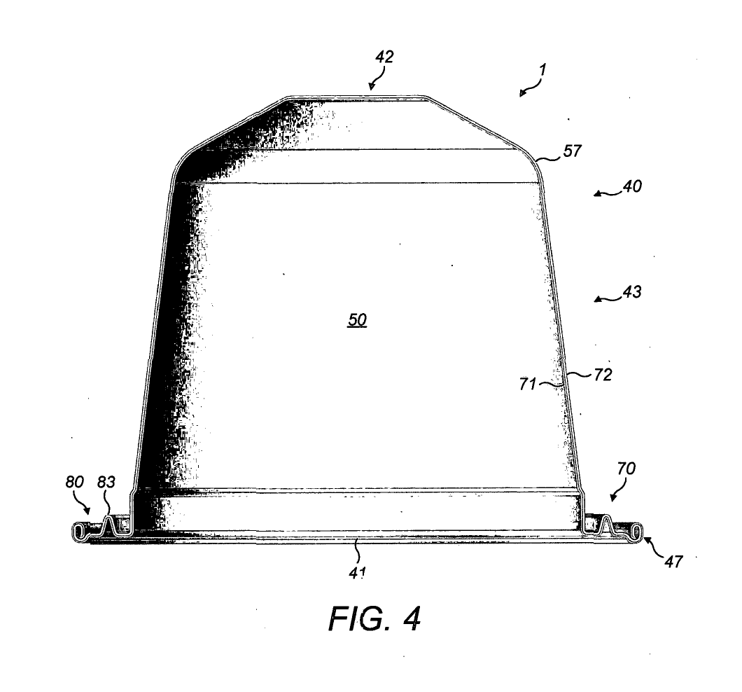

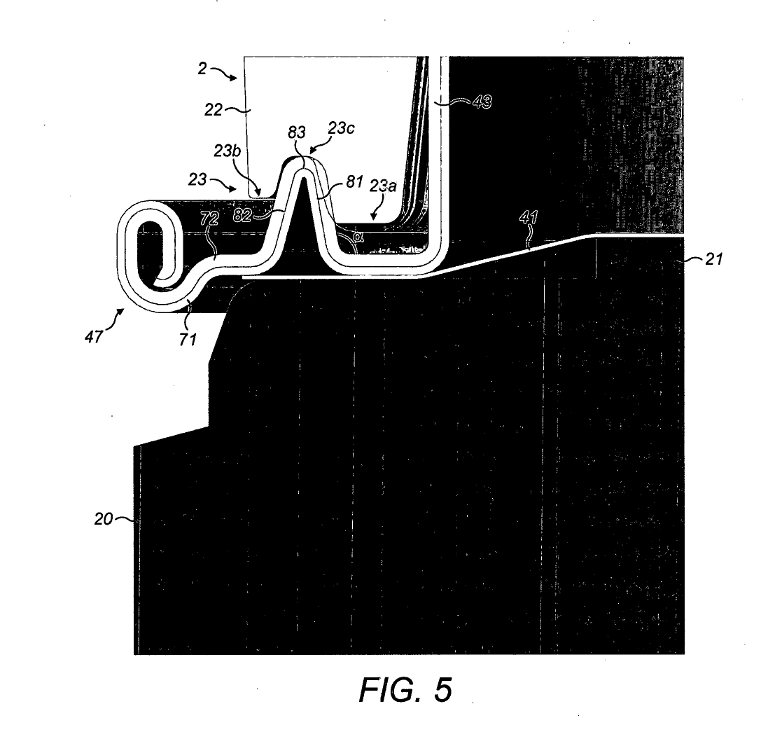

FIGS. 4 and 5 illustrate a second embodiment of capsule 1. Features corresponding to those of the first embodiment are denoted by corresponding reference signs. Features of the first embodiment and this embodiment may be interchanged and combined as desired. In addition, in the following description only differences between the embodiments will be described in detail. In other respects the reader is directed to the description of the prior embodiment.

The cup-shaped body 40 differs from that of the first embodiment in the configuration and geometry of the outwardly extending flange 70.

The outwardly-extending flange 70 is provided with a raised ridge 80 formed from the laminate material. The raised ridge 80 is formed by bending of the laminate material, i.e. the raised ridge 80 is a convolution in the material rather than a locally thickened region.

The raised ridge 80 comprises an inner wall 81 that faces the side wall 43 of the capsule 1 and an outer wall 82 that faces away from the side wall 43. An apex 83 of the raised ridge 80 joins the inner wall 81 and the outer wall 82. The raised ridge 80 may have a generally triangular shape and in particular the inner wall 81 may be angled, such that an angle a at a junction between a remainder of the flange 70 and the inner wall 81 is from 90° to 120°, preferably 105°.

The apex 83 is located at a higher level relative to a remainder of the outwardly extending flange 70. The raised ridge 80 may have a height of 0.75 to 2.5 mm, preferably 1.0 to 1.5 mm, more preferably 1.3 mm.

In use, as shown in FIG. 5, on closure of the enclosing member 2 a leading edge 23 of the enclosing member 2 contacts the at least one raised ridge 80 and forms a seal therewith. FIG. 5 illustrates that the leading edge 23 of the enclosing member 2 may comprise an inner rim 23a and an outer rim 23b which are concentric and spaced apart from one another to define a recess 23c there between, which may be generally annular (although may have interruptions around its circumference). Preferably, on closure of the enclosing member 2 the inner rim 23a of the leading edge 23 contacts the inner wall 81 of the raised ridge and forms a seal therewith. At the same time (or shortly thereafter) the apex 83 of the raised ridge 80 is received in the recess 23c. The raised ridge 80 (and the remainder of the flange 70) may be driven downwards by the action of the enclosing member 2 on the inner wall 81 and/or apex 83 which may cause the inner wall 81 and/or outer wall 82 to buckle and deform/crumple. In addition, as in the first embodiment, the deformation of the laminate material due to the compressibility of the polymer layer 72 allows for the laminate material to conform to the shape of the leading edge 23. In particular the polymer layer 72 is able to fill any gaps arising due to the presence of grooves in the leading edge 23.

Downward movement of the enclosing member 2 may continue beyond the point illustrated in FIG. 5 until the inner rim 23a contacts and bears against the remainder of the outwardly extending flange 70.

Piercing and brewing of a beverage from the capsule 1 may be as described above in the first embodiment.

1. A beverage producing system comprising:
a capsule containing beverage ingredients; and
a beverage preparation machine;
the capsule comprising a cup-shaped body and a lid; the cup-shaped body having a base and a side wall and the lid being sealed to the cup-shaped body;
the capsule being designed for insertion into the beverage preparation machine to permit a pressurised liquid to be flowed through the capsule in order to produce a beverage from interaction with the beverage ingredients;
the beverage preparation machine having an enclosing member adapted to be selectively movable between an open position to permit insertion of the capsule into the beverage preparation machine and a closed position in which the enclosing member sealingly engages the capsule;
wherein at least a portion of the cup-shaped body is formed from a laminate material comprising at least an aluminium layer and a polymer layer.

2. A beverage producing system as claimed in claim 1, wherein the cup-shaped body comprises an outwardly-extending flange at an end of the capsule distal the base; and optionally at least the outwardly-extending flange is formed from the laminate material.

3. (canceled)

4. A beverage producing system as claimed in claim 1, wherein the cup-shaped body is wholly formed from the laminate material.

5. A beverage producing system as claimed in claim 1, wherein the cup-shaped body comprises a unitary piece of laminate material.

6. A beverage producing system as claimed in claim 1, wherein the polymer layer comprises a material selected from the group of:
polyvinyl chloride (PVC), polypropylene (PP), low density polyethylene (LDPE), medium density polyethylene (MDPE), high density polyethylene (HDPE), fluorinated ethylene propylene (FEP), polytetrafluoroethylene (PTFE), polyethylene terephthalate (PET), polyamide (PA), ethylene propylene diene monomer (EPDM), polychloroprene or isobutylene.

7. A beverage producing system as claimed in claim 1, wherein the polymer layer has a thickness greater than or equal to 100 microns, optionally greater than or equal to 120 microns, optionally greater than or equal to 130 microns and optionally no more than 300 microns.

8-10. (canceled)

11. A beverage producing system as claimed in claim 1, wherein the aluminium layer has a thickness in the range of 80 to 150 microns.

12. A beverage producing system as claimed in claim 1, wherein the polymer layer is provided towards an exterior of the capsule and the aluminium layer is provided towards an interior of the capsule.

13-14. (canceled)

15. A beverage producing system as claimed in claim 1, wherein the cup-shaped body is a cold-formed cup-shaped body.

16. (canceled)

17. A beverage producing system as claimed in claim 1, wherein the laminate material is adapted to form a sealing interface with a leading edge of the enclosing member.

18. (canceled)

19. A beverage producing system as claimed in claim as dependent on claim 2, wherein the outwardly-extending flange comprises at least one raised ridge formed from the laminate material; and optionally on closure of the enclosing member a leading edge of the enclosing member contacts the at least one raised ridge and forms a seal therewith.

20-21. (canceled)

22. A beverage producing system as claimed in claim 19, wherein the raised ridge comprises an inner wall facing the side wall; and optionally on closure of the enclosing member a leading edge of the enclosing member contacts the inner wall of the raised ridge and forms a seal therewith.

23. (canceled)

24. A beverage producing system as claimed in claim 22, wherein the inner wall of the raised ridge is angled, such that an angle a at a junction between a remainder of the flange and the inner wall is from 90° to 120°, preferably 105°.

25. A beverage producing system as claimed in claim 19, wherein the raised ridge comprises an apex, and a leading edge of the enclosing member comprises an inner rim and an outer rim and a recess located between the inner rim and the outer rim, wherein on closure of the enclosing member the apex of the raised ridge is received in the recess between the inner rim and the outer rim.

26. A beverage producing system as claimed in claim 19, wherein the raised ridge has a height of 0.75 to 2.5 mm, preferably 1.0 to 1.5 mm, more preferably 1.3 mm.

27-32. (canceled)

33. A beverage producing system as claimed in claim 1, wherein a leading edge of the enclosing member comprises a plurality of grooves or indentations, and the laminate material is adapted to conform to the grooves or indentations on closure of the enclosing member to provide an effective seal.

34. A capsule for preparing a beverage comprising a cup-shaped body and a lid; the cup-shaped body having a base and a side wall and the lid being sealed to the cup-shaped body;
the capsule being designed for insertion into a beverage preparation machine to permit a pressurised liquid to be flowed through the capsule in order to produce a beverage from interaction with the beverage ingredients;
the beverage preparation machine being of the type having an enclosing member adapted to be selectively movable between an open position to permit insertion of the capsule into the beverage preparation machine and a closed position in which the enclosing member sealingly engages the capsule;
wherein at least a portion of the cup-shaped body is formed from a laminate material comprising at least an aluminium layer and a polymer layer.

35. A capsule as claimed in claim 34, wherein the cup-shaped body comprises an outwardly-extending flange at an end of the capsule distal the base; and optionally at least the outwardly-extending flange is formed from the laminate material.

36. (canceled)

37. A capsule as claimed claim 34, wherein the cup-shaped body is wholly formed from the laminate material.

38. A capsule as claimed claim 34, wherein the cup-shaped body comprises a unitary piece of laminate material.

39. A capsule as claimed in claim 34, wherein the laminate material comprises only a single aluminium layer and a single polymer layer (with optionally one or more lacquer layers).

40. A capsule as claimed in claim 34, wherein the polymer layer comprises a material selected from the group of: polyvinyl chloride (PVC), polypropylene (PP), low density polyethylene (LDPE), medium density polyethylene (MDPE), high density polyethylene (HDPE), fluorinated ethylene propylene (FEP), polytetrafluoroethylene (PTFE), polyethylene terephthalate (PET), polyamide (PA), ethylene propylene diene monomer (EPDM), polychloroprene or isobutylene.

41. A capsule as claimed in claim 34, wherein the polymer layer has a thickness greater than or equal to 100 microns, optionally greater than or equal to 120 microns, optionally greater than or equal to 130 microns, and optionally no more than 300 microns.

42-44. (canceled)

45. A capsule as claimed claim 34, wherein the aluminium layer has a thickness in the range of 80 to 150 microns.

46. A capsule as claimed in claim 34, wherein the polymer layer is provided towards an exterior of the capsule and the aluminium layer is provided towards an interior of the capsule.

47-48. (canceled)

49. A capsule as claimed in claim 34, wherein the cup-shaped body is a cold-formed or warm-formed cup-shaped body.

50. A capsule as claimed in claim 35, wherein the outwardly-extending flange comprises at least one raised ridge formed from the laminate material; and optionally the raised ridge comprises an apex that is located at a higher level relative to a remainder of the flange.

51. (canceled)

52. A capsule as claimed in claim 50, wherein the raised ridge comprises an inner wall facing the side wall; and optionally the inner wall of the raised ridge is angled, such that an angle a at a junction between a remainder of the flange and the inner wall is from 90° to 120°, preferably 105°.

53. (canceled)

54. A capsule as claimed in claim 50, wherein the raised ridge has a height of 0.75 to 2.5 mm, preferably 1.0 to 1.5 mm, more preferably 1.3 mm.

55. A capsule as claimed in claim 34, wherein the capsule further comprises a rim; and optionally the rim is integral with the cup-shaped aluminium body; and optionally the rim is formed by a rolled-over portion of the side wall.

56-60. (canceled)

61. A method for preparing a beverage comprising the steps of:
providing a capsule as claimed in claim 34;
providing a beverage preparation machine having an enclosing member;
moving the enclosing member into an open position;
inserting the capsule into the beverage preparation machine;
closing the enclosing member so as to sealingly engage the enclosing member with the capsule;
flowing a pressurised liquid through the capsule to produce a beverage from interaction with the beverage ingredients; and
outputting the beverage for consumption;
wherein on closure, the enclosing member engages the laminate material of the capsule to thereby form at least one sealing interface between the enclosing member and the capsule.

62-63. (canceled)
